(19) United States
(12) Patent Application Publication
(10) Pub. No.: US 2021/0179455 A1
(43) Pub. Date: Jun. 17, 2021

(54) HYDROGEN PEROXIDE WATER MANUFACTURING DEVICE

(71) Applicants: KABUSHIKI KAISHA TOSHIBA, Minato-ku (JP); TOSHIBA INFRASTRUCTURE SYSTEMS & SOLUTIONS CORPORATION, Kawasaki-shi (JP)

(72) Inventors: Naohiko SHIMURA, Atsugi (JP); Seiichi MURAYAMA, Fuchu (JP); Kanako NAKAJIMA, Yokohama (JP); Ryutaro MAKISE, Yokohama (JP); Kie KUBO, Toshima (JP)

(73) Assignees: KABUSHIKI KAISHA TOSHIBA, Minato-ku (JP); TOSHIBA INFRASTRUCTURE SYSTEMS & SOLUTIONS CORPORATION, Kawasaki-shi (JP)

(21) Appl. No.: 16/761,630

(22) PCT Filed: Oct. 4, 2018
(86) PCT No.: PCT/JP2018/037245

§ 371 Date: May 5, 2020

(30) Foreign Application Priority Data
Nov. 10, 2017 (JP) 2017-217448

(51) Int. Cl. C02F 1/461; C02F 1/467; B01F 5/04; B01F 3/04

(52) U.S. Cl. CPC C02F 1/46109; C02F 1/4672; B01F 5/043; B01F 2215/0052; C02F 2001/46161; C02F 2001/46138; C02F 2001/46171; B01F 3/0446

(57) ABSTRACT

A hydrogen peroxide water manufacturing device includes an ejector unit including an introduction-side diameter-increasing portion to which water to be treated is introduced, a nozzle portion connected to the introduction-side diameter-increasing portion and having an introduction opening to which a source gas containing oxygen gas is introduced from outside, on a side wall, and a discharge-side diameter-increasing portion that is connected to the nozzle portion and from which the water to be treated mixed with the source gas is discharged, and an electrolysis unit disposed downstream of the ejector unit and including electrolytic electrodes to electrolyze the discharged water to be treated mixed with the source gas and generate hydrogen peroxide by using the source gas as a source.

### FIELD

Embodiments of the present invention relate to a hydrogen peroxide water manufacturing device.

### BACKGROUND

In the field of, for example, service water, waste water, industrial effluent, and swimming pool, ozone and UV lamps is used for processes such as oxidative decomposition, sterilization, and deodorization of organic matter in water are conventionally used. The oxidation with ozone and UV lamps can achieve hydrophilizing or low-molecular, but cannot achieve mineralization. Use of ozone or a UV lamp cannot decompose refractory organic matter such as dioxin and 1,4-dioxane.

To decompose the refractory organic matter in water, the advanced oxidation process has been proposed in which the refractory organic matter is oxidized and decomposed by using OH radicals having a greater oxidation power than active species according to ozone or UV lamps.

The advanced oxidation processes include a method of adding ozone to hydrogen peroxide water and a method of irradiating hydrogen peroxide water using a UV lamp to produce OH radicals.

### CITATION LIST

### Patent Literature

Patent Literature 1: Japanese Patent Application Laid-open No. 2002-531704

Patent Literature 2: Japanese Patent Application Laid-open No. 2010-137151

Patent Literature 3: Japanese Patent Application Laid-open No. 2013-108104

### SUMMARY OF THE INVENTION

### Problem to be Solved by the Invention

The method of using ozone or a UV lamp and hydrogen peroxide requires a storage facility and an injection facility for hydrogen peroxide, which is a deleterious substance. Using hydrogen peroxide requires strict control to ensure safety.

The present invention has been made to solve the above problem, and has an object to provide a hydrogen peroxide water manufacturing device that can manufacture hydrogen peroxide water continuously.

### Means for Solving Problem

A hydrogen peroxide water manufacturing device according to an embodiment includes an ejector unit including an introduction-side diameter-increasing portion to which water to be treated is introduced, a nozzle portion connected to the introduction-side diameter-increasing portion and having an introduction opening to which a source gas containing oxygen gas is introduced from outside, on a side wall, and a discharge-side diameter-increasing portion that is connected to the nozzle portion and from which the water to be treated mixed with the source gas is discharged; and an electrolysis unit disposed downstream of the ejector unit and including electrolytic electrodes to electrolyze the discharged water to be treated mixed with the source gas and generate hydrogen peroxide by using the source gas as a source.

### BRIEF DESCRIPTION OF DRAWINGS

FIG. 1 is a block diagram illustrating a schematic configuration of a water treatment system according to embodiments.

FIG. 2 is an outer perspective view of a water treatment unit.

FIG. 3 is a schematic sectional view of the water treatment unit.

FIG. 4 is a diagram illustrating an example configuration of an electrolytic electrode group.

FIG. 5 is a diagram illustrating an example configuration of an electrolytic electrode group including a plurality of pairs of electrodes.

FIG. 6 is a diagram illustrating electrodes according to a second embodiment.

FIG. 7 is a diagram illustrating an electrode according to a third embodiment.

FIG. 8 is a diagram illustrating electrodes according to a fourth embodiment.

### DETAILED DESCRIPTION

The following describes embodiments with reference to the accompanying drawings.

### [1] First Embodiment

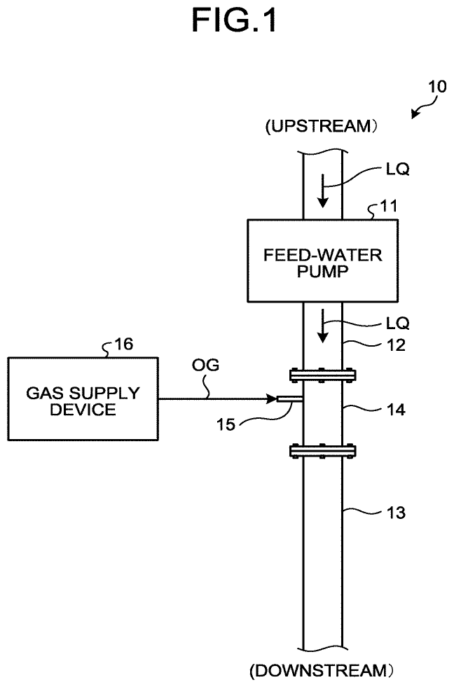

FIG. 1 is a block diagram illustrating a schematic configuration of a water treatment system according to the embodiments.

This water treatment system 10 includes a feed-water pump 11 that supplies water LQ to be treated under pressure, an upstream existing pipe 12, a downstream existing pipe 13, a water treatment unit 14 disposed between the upstream existing pipe 12 and the downstream existing pipe 13 and functioning as a hydrogen peroxide water manufacturing device that continuously manufacture hydrogen peroxide water, and a gas supply device 16 that can supply a source gas containing oxygen via a gas supply pipe 15 of the water treatment unit 14.

The gas supply device 16 supplies, as the source gas, oxygen-containing gas OG that contains oxygen, such as oxygen gas or air gas.

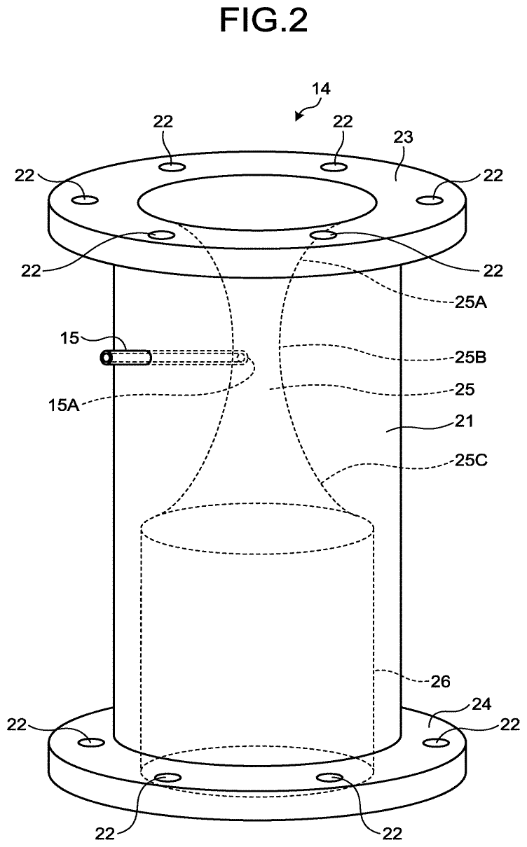

FIG. 2 is an outer perspective view of the water treatment unit.

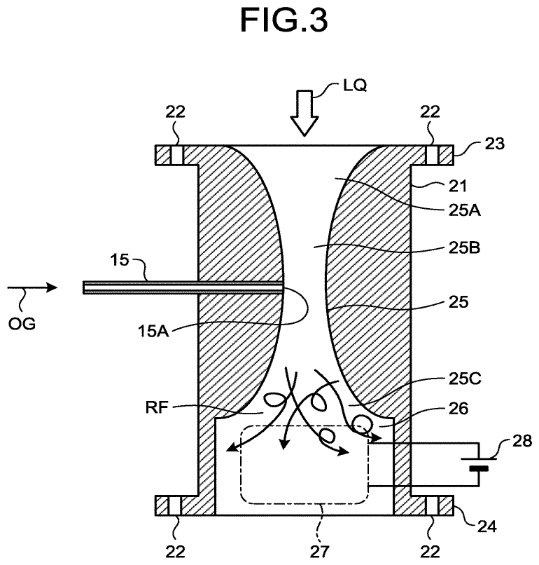

FIG. 3 is a schematic sectional view of the water treatment unit.

The water treatment unit 14 includes a body 21, a pair of flanges 23, 24 having a plurality of holes 22 for bolt fastening, and the gas supply pipe 15 provided close to the flange 23 in the body 21.

Close to the flange 23 (close to an upper side in FIG. 2) in the body 21, disposed are an ejector unit 25 having a flow path diameter that gradually decrease and then gradually increase, and having an ozone supply opening 15A for the gas supply pipe 15 at the portion where the flow path diameter is smallest, and an electrolysis unit 26 including electrodes (or an electrode group) described later to generate hydrogen peroxide (H₂O₂). The ejector unit 25 and the electrolysis unit 26 function as the hydrogen peroxide water manufacturing device.

The ejector unit 25 has an introduction-side diameter-increasing portion 25A having an inner diameter gradually increasing toward an introduction side of the water LQ to be treated, a nozzle portion 25B, and a discharge-side diameter-increasing portion 25C having an inner diameter gradually increasing toward a discharge side of the water LQ to be treated.

Here, the treatment principle of the water treatment unit 14 will be described.

When the feed-water pump 11 supplies the water LQ to be treated to the ejector unit 25 of the water treatment unit 14 under pressure, the speed (flow rate) of the water LQ to be treated gradually increases due to the gradually reducing flow path diameter of the ejector unit 25 from the introduction-side diameter-increasing portion 25A toward the nozzle portion 25B.

The flow rate of the water LQ to be treated is highest at the nozzle portion 25B having the smallest flow path diameter of the ejector unit 25, that is, highest at the portion having the ozone supply opening 15A for the gas supply pipe 15, and the water LQ to be treated is depressurized at the nozzle portion 25B due to the Venturi effect.

The depressurized state causes the oxygen-containing gas OG supplied from the gas supply device 16 as the source gas to be introduced to the nozzle portion 25B of the ejector unit 25.

The water LQ to be treated then flows into the discharge-side diameter-increasing portion 25C having a gradually increasing flow path diameter, of the ejector unit 25, in which the flow rate decreases and the water pressure increases sharply, thereby producing a turbulent flow. The water LQ to be treated and the oxygen-containing gas OG are mixed strongly.

The water LQ to be treated and the oxygen-containing gas OG mixing substantially uniformly flows into the electrolysis unit 26, at which hydrogen peroxide (H₂O₂) is generated by the electrodes in the electrolysis unit 26 by using oxygen gas contained in the oxygen-containing gas OG as the source in accordance with formula (1) below.

O₂+2H⁺+2e⁻→H₂O₂ (1)

As described above, when the water LQ to be treated flows into the discharge-side diameter-increasing portion 25C having a gradually increasing flow path diameter, of the ejector unit 25, the flow rate decreases and the pressure increases sharply.

This produces a turbulent flow RF as illustrated in FIG. 3 and the water LQ to be treated and the oxygen-containing gas OG are mixed strongly. In this case, it is desired that hydrogen peroxide is still uniformly distributed in the electrolysis unit 26.

In this regard, it is desired that the electrodes for use in electrolytic processes in the electrolysis unit 26 are disposed not to interrupt the produced turbulent flow as much as possible.

The following describes in detail the electrodes for use in electrolytic processes in the electrolysis unit 26.

In the electrolysis unit 26, as illustrated in FIG. 3, an electrolytic electrode group 27 is disposed immediately after the discharge-side diameter-increasing portion 25C of the ejector unit 25 and is supplied with direct current for use in electrolytic processes from an external direct current power source 28.

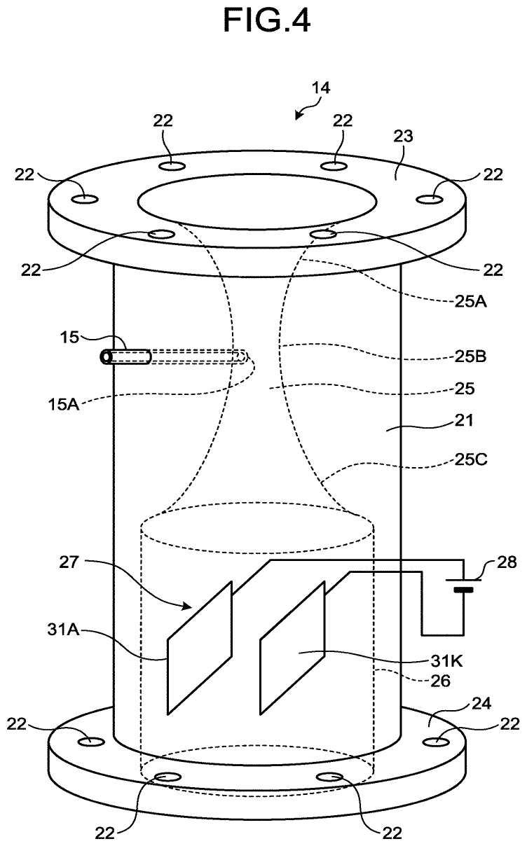

FIG. 4 is a diagram illustrating an example configuration of the electrolytic electrode group.

The electrolytic electrode group 27 in the electrolysis unit 26 includes an anode electrode 31A and a cathode electrode 31K having a plate-like shape.

As illustrated in FIG. 4, the anode electrode 31A and the cathode electrode 31K are sufficiently spaced apart and thus never interrupt the turbulent flow RF produced in the discharge-side diameter-increasing portion 25C.

Although this structure does not interrupt the turbulent flow RF, it may fail to increase the reaction rate as much as expected and fail to increase the generation efficiency of hydrogen peroxide (H₂O₂) because only the anode electrode 31A generates hydrogen peroxide by using oxygen gas contained in the oxygen-containing gas OG as the source.

In this regard, an electrode arrangement that can increase the reaction rate is desired.

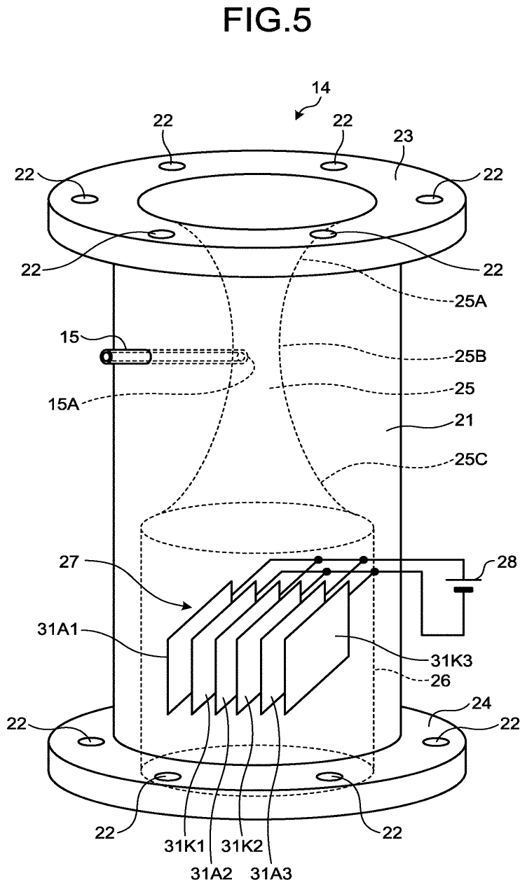

FIG. 5 is a diagram illustrating an example configuration of an electrolytic electrode group including a plurality of pairs of electrodes.

In a first embodiment, as illustrated in FIG. 5, anode electrodes 31A1 to 31A3 and cathode electrodes 31K1 to 31K3 are alternately arranged, and a plurality of pairs of electrodes form the electrolytic electrode group 27 of the electrolysis unit 26.

In this case, an electrolytic reaction takes place between each pair of electrodes (e.g., between the anode electrode 31A1 and the cathode electrode 31K1). This configuration can efficiently generate hydrogen peroxide and can manufacture hydrogen peroxide water continuously.

According to the first embodiment described above, hydrogen peroxide water can be manufactured efficiently and continuously.

### [2] Second Embodiment

In the first embodiment above, plate electrodes are described. In a second embodiment below, a more practical configuration is described that increases the manufacturing efficiency of hydrogen peroxide water by preventing the turbulent flow from being regulated.

The second embodiment mainly focuses on the structure of the electrodes, and the electrode arrangement is the same as that of the first embodiment.

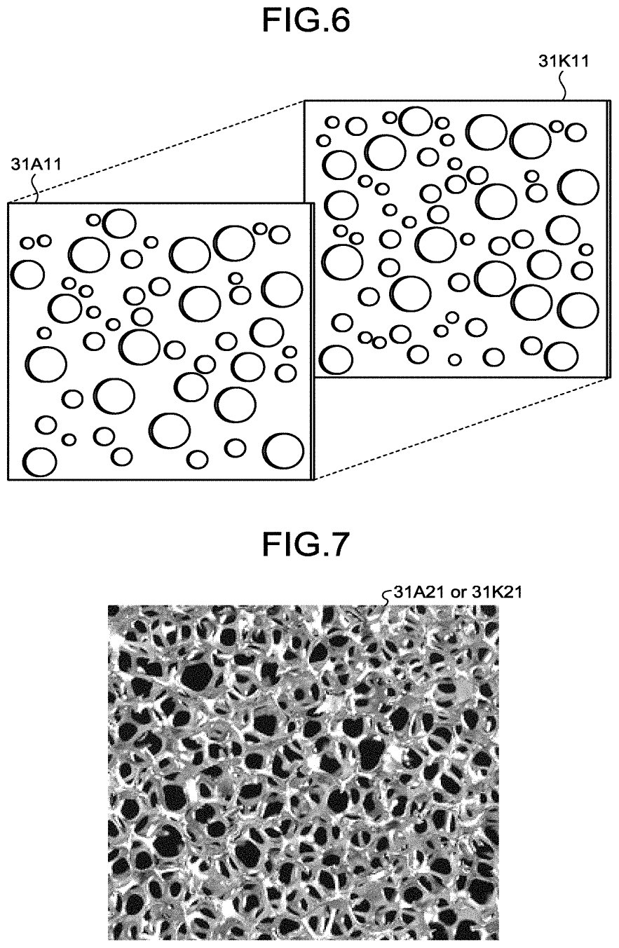

FIG. 6 is a diagram illustrating electrodes according to the second embodiment.

The electrodes according to the second embodiment are porous plate electrodes having a plurality of randomly arranged holes with different diameters, and include an anode electrode 31A11 and a cathode electrode 31K11 as an electrode pair.

In this structure, the water LQ to be treated flowing between the anode electrode 31A11 and the cathode electrode 31K11 and passing therethrough becomes a random turbulent flow. This structure can increase the generation efficiency of hydrogen peroxide and thus increase the manufacturing efficiency of hydrogen peroxide water.

If the pairs of electrodes illustrated in FIG. 5 are formed with the anode electrode 31A11 and the cathode electrode 31K11 according to the second embodiment, which are porous plate electrodes having a plurality of randomly arranged holes with different diameters, the manufacturing efficiency of hydrogen peroxide water increases in proportion to the increased number of electrodes as long as the flow path resistance is not significantly increased.

### [3] Third Embodiment

In the first and the second embodiments above, plate electrodes are described. In a third embodiment below, an electrode having a three-dimensional shape is described.

FIG. 7 is a diagram illustrating an electrode according to the third embodiment.

In FIG. 7, black portions indicate pores (openings).

As illustrated in FIG. 7, an anode electrode 31A21 or a cathode electrode 31K21 according to the third embodiment has a three-dimensional porous shape (like sponge), and thus can have a sufficient surface area of the electrode and can keep the turbulent flow of the water LQ to be treated.

It is desired that the surface of the cathode electrode 31K21 is hydrophobic so as to easily take oxygen gas into the electrode surface as the source of hydrogen peroxide. In this regard, the cathode electrode 31K21 is made of, for example, a porous carbon electrode as the electrode core member coated with a polytetrafluoroethylene suspension, or what is called a Teflon (registered trademark) suspension (for providing hydrophobic properties), and coated with conductive carbon powder (for providing porous properties).

According to the third embodiment, the water LQ to be treated flowing and passing between the anode electrode 31A21 and the cathode electrode 31K21 becomes a random turbulent flow. This structure can increase the manufacturing efficiency of hydrogen peroxide water.

### [4] Fourth Embodiment

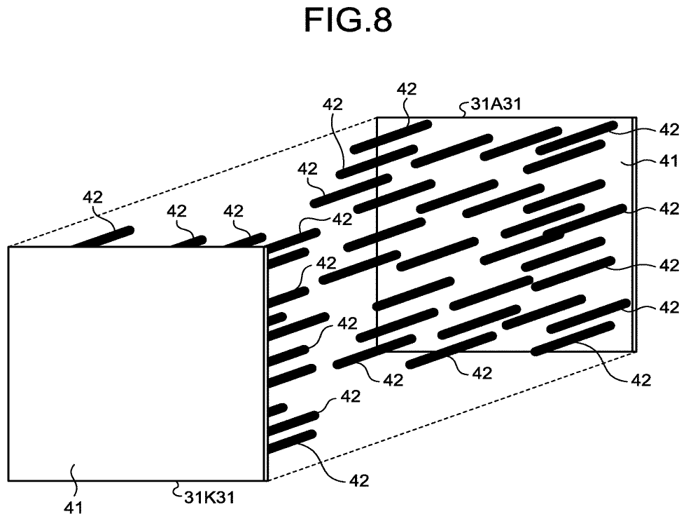

FIG. 8 is a diagram illustrating electrodes according to a fourth embodiment.

As illustrated in FIG. 8, an anode electrode 31A31 and a cathode electrode 31K31 according to the fourth embodiment each include an electrode base 41 and a plurality of rod-shaped electrodes 42 projecting on the electrode base 41, thereby having a pin holder shape.

The rod-shaped electrodes 42 of the anode electrode 31A31 and the cathode electrode 31K31 are randomly disposed at positions not interfering with one another when the anode electrode 31A31 and the cathode electrode 31K31 are disposed close to and opposite to each other. This structure can provide a sufficient surface area of the electrodes and can keep the turbulent flow of water LQ to be treated.

In the same manner as the cathode electrode 31K21 according to the third embodiment, it is desired that the surface of the cathode electrode 31K31 is hydrophobic so as to easily take oxygen gas into the electrode surface as the source of hydrogen peroxide. In this regard, the cathode electrode 31K31 is made of, for example, an electrode core member coated with a Teflon (registered trademark) suspension (for providing hydrophobic properties) and conductive carbon powder (for providing porous properties).

According to the fourth embodiment, the water LQ to be treated flowing and passing between the anode electrode 31A31 and the cathode electrode 31K31 becomes a random turbulent flow. This structure can increase the manufacturing efficiency of hydrogen peroxide water.

### [5] Effects of Embodiments

According to the embodiments above, a simple and low-cost hydrogen peroxide water manufacturing device can be implemented without using hydrogen peroxide as a reagent.

Although several embodiments according to the present invention have been described, these embodiments are presented for illustrative purposes only and are not intended to limit the scope of the invention. These novel embodiments can be implemented in various other forms, and various omissions, substitutions, and modifications can be made within the scope and spirit of the invention. The embodiments and modifications thereto are within the scope and spirit of the invention and are within the invention described in claims and equivalents thereof.

1. A hydrogen peroxide water manufacturing device comprising:
an ejector unit including an introduction-side diameter-increasing portion to which water to be treated is introduced, a nozzle portion connected to the introduction-side diameter-increasing portion and having an introduction opening to which a source gas containing oxygen gas is introduced from outside, on a side wall, and a discharge-side diameter-increasing portion that is connected to the nozzle portion and from which the water to be treated mixed with the source gas is discharged; and
an electrolysis unit disposed downstream of the ejector unit and including electrolytic electrodes to electrolyze the discharged water to be treated mixed with the source gas and generate hydrogen peroxide by using the source gas as a source.

2. The hydrogen peroxide water manufacturing device according to claim 1, wherein the electrolytic electrodes are plate electrodes having a plurality of randomly arranged holes with different diameters.

3. The hydrogen peroxide water manufacturing device according to claim 1, wherein the electrolytic electrodes are three-dimensionally formed electrodes comprising a porous material having through-holes.

4. The hydrogen peroxide water manufacturing device according to claim 3, wherein the electrolytic electrodes include a cathode electrode comprising:
an electrode core member,
a porous carbon layer stacked on the electrode core member, and
a hydrophobic layer formed on a surface of the porous carbon layer by coating.

5. The hydrogen peroxide water manufacturing device according to claim 4, wherein the hydrophobic layer is formed by the coating with a polytetrafluoroethylene suspension.

6. The hydrogen peroxide water manufacturing device according to claim 1, wherein the electrolytic electrodes include a plurality of pairs of electrodes including anode electrodes and cathode electrodes.
